(19) United States
(12) Patent Application Publication
(10) Pub. No.: US 2024/0400449 A1
(43) Pub. Date: Dec. 5, 2024

(54) GEOPOLYMER FORMULATION AND PROCESS THEREOF

(71) Applicant: Louisiana Tech Research Corporation; of Louisiana Tech University Foundation, Inc., Ruston, LA (US)

(72) Inventors: Sudhir S. Amritphale, Ruston, LA (US); John Matthews, Choudrant, LA (US); Richard Edwards, St. Francisville, LA (US); Shaik Hussain, Ruston, LA (US)

(21) Appl. No.: 18/665,905

(22) Filed: May 16, 2024

Related U.S. Application Data
(60) Provisional application No. 63/470,741, filed on Jun. 2, 2023.

(51) Int. Cl. C04B 12/00; C04B 22/06; C04B 28/00; C04B 40/00; C04B 40/02

(52) U.S. Cl. CPC C04B 12/005; C04B 22/062; C04B 28/006; C04B 40/0014; C04B 40/0046; C04B 40/0263; C04B 2201/50

(57) ABSTRACT

A geopolymer formulation is suitable for making a functional geopolymer when combined with an aggregate and water. The geopolymer formulation includes a precursor including an oxide and an activator. The geopolymer formulation is a dry solid powder with a particle size in the range of 45 to 60 microns.

### TECHNICAL FIELD

The present disclosure generally relates to cement-free advanced geopolymer formulations and methods for making them. The geopolymer formulations may utilize techno-economically feasible indigenous/local soil-mineral strata resource materials and may produce geopolymer for making advanced construction materials necessary for civilian infrastructure as well as for strategic and critical defense applications in an environmentally friendly approach.

### BACKGROUND

Unless otherwise indicated herein, the materials described in this section are not prior art to the claims herein and are not admitted as being prior art by inclusion in this section.

Conventional geopolymeric systems may utilize fly ashes and slags as primary raw material sources of silica, alumina, and calcium along with solutions of alkaline activator for making geopolymer paste, mortar, and concrete. Fly ashes may be generated in thermal power plants due to the burning of coal and may be a substantial source of liberated carbon dioxide, a greenhouse gas considered to contribute to the serious concern about climate change leading to hurricanes, global warming, etc. The transportation of fly ashes from distant thermal power plants may become cost-prohibitive and the flying nature of fly ashes may require special care in handling and transporting.

### SUMMARY

Existing challenges associated with the foregoing, as well as other challenges, are overcome by the presently disclosed geopolymer formulation. One embodiment of the present disclosure is a geopolymer formulation for making a functional geopolymer when combined with an aggregate and water. The geopolymer formulation includes a precursor and an activator. The precursor includes an oxide. The geopolymer formulation is a dry solid powder with a particle size in the range of 45 to 60 microns.

In aspects, the precursor includes fly ash, blast furnace slag, and metakaolin, and the activator includes sodium hydroxide and sodium silicate and the geopolymer formulation is for a fast setting geopolymer mortar/concrete.

In aspects, the precursor includes fly ash at 10-40 weight %, blast furnace slag at 60-90 weight %, and metakaolin at 20-50 weight %, and the activator includes sodium hydroxide at 10-15 weight % and sodium silicate at 25-37 weight %.

In aspects, the precursor includes fly ash and mullite, and the activator includes potassium hydroxide and potassium silicate and the geopolymer formulation is for a refractory geopolymer composite.

In aspects, the precursor includes fly ash at 10-40 weight % and mullite at 50-70 weight % and the activator includes potassium hydroxide at 10-15 weight % and potassium silicate at 25-37 weight %.

In aspects, the precursor includes fly ash, blast furnace slag, and metakaolin, and the activator includes sodium hydroxide and sodium silicate or rice husk ash and the geopolymer formulation is for a fast-setting geopolymer mortar/concrete.

In aspects, the precursor includes fly ash at 10-40 weight %, blast furnace slag at 60-90 weight %, metakaolin at 20-50% weight, and the activator includes sodium hydroxide at 10-15 weight % and sodium silicate at 25-37 weight % or rice husk ash at 5-10 weight %.

In aspects, the precursor includes fly ash and mullite, and the activator includes potassium hydroxide and potassium silicate or rice husk ash and the geopolymer formulation is suitable for making a refractory geopolymer composite.

In aspects, the precursor comprises fly ash at 10-40% and mullite at 50-70%, the activator comprises potassium hydroxide at 10-15 weight % and potassium silicate at 25-37 weight % or rice husk ash at 7-13 weight %, and the geopolymer formulation is suitable for making a refractory geopolymer composite.

In aspects, the geopolymer formulation produces a fast setting geopolymer concrete composition with a compressive strength of 2000 psi after curing at ambient temperature for 24 hours.

In aspects, the geopolymer formulation produces a fast setting geopolymer concrete composition with a compressive strength of 3000 psi after curing at ambient temperature for three days or heat curing at 70° C. for 24 hours.

In aspects, the geopolymer formulation produces a fast-setting geopolymer concrete composition with a compressive strength of 5400 psi after curing at ambient temperature for 28 days.

Another embodiment of the present disclosure includes a method of making a geopolymer formulation. The method includes placing a precursor into a chamber of milling equipment. The method includes placing activators into the chamber of the milling equipment. The method includes milling the precursor and the activator to produce a dry solid powder with a particle size in the range of 45 to 60 microns and produce a geopolymer formulation for making a functional geopolymer when combined with an aggregate and water.

In aspects, the method further includes mixing aggregate and water with the cured dry powder to produce a geopolymer mortar and casting the geopolymer mortar into a mold.

In aspects the method further includes heat curing the geopolymer mortar in the mold at a temperature of about 70° C. for about 24 hours.

In aspects, the method further includes ambient curing the geopolymer mortar in the mold at ambient temperature for about 1-150 days.

In aspects, the method further includes heat curing the geopolymer mortar in the mold at a temperature of about 70° C. for about 3.5 hours and microwave curing the geopolymer mortar in the mold at intervals of 10 seconds for about 4 minutes.

In aspects, the method further includes heat curing the geopolymer mortar in the mold at a temperature of about 70° C. for about 5 hours and microwave curing the geopolymer mortar in the mold at intervals of about 30 seconds for about 1 minute.

In aspects, the method further includes heat curing the geopolymer mortar in the mold at a temperature of about 70° C. for about 3.5 hours and microwave curing the geopolymer mortar in the mold at intervals of about 30 seconds for about 1 minute.

Another embodiment of the present disclosure is a geopolymer formulation for making a functional geopolymer when combined with an aggregate and water. The geopolymer formulation includes a precursor including fly ash and blast furnace slag and an activator including sodium hydroxide and sodium silicate or rice husk ash. The geopolymer formulation is a dry solid powder with a particle size in the range of 45 to 60 microns. The geopolymer formulation is for a refractory geopolymer composite with a compressive strength of 5900 psi when cured at 160° F. for 24 hours prior to high temperature exposures.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates an example system that can be utilized to produce a geopolymer formulation in accordance with the present disclosure;

FIG. 2 illustrates an example system that can be utilized to produce a geopolymer mortar or concrete utilizing the geopolymer formulation of FIG. 1 in accordance with the present disclosure; and

FIG. 3 illustrates a flow diagram for an example method for making a geopolymer formulation in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Geopolymer compositions may be in a solid powder form and may be used for making various rapid setting and fire resistant functional geopolymer materials when water is added. Such geopolymer formulations may obviate the need for handling hazardous alkaline activator solutions that are required for other geopolymer compositions.

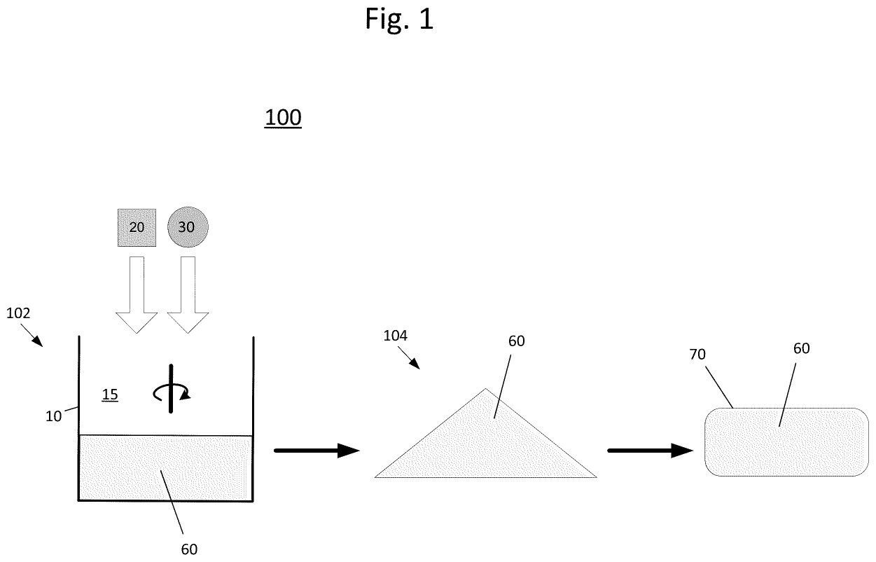

FIG. 1 shows a system 100 and method for making a geopolymer formulation arranged in accordance with at least some embodiments described herein. As discussed in more detail below, the geopolymer formulation produced using system 100 may be an effective building material for general construction and for high temperature resistant applications.

System 100 may include milling equipment 10 with a chamber 15, a precursor 20, an activator 30, and a heater 50. Milling equipment 10 may dry grind or dry ground material placed within chamber 15. Milling equipment 10 may be a horizontal or vertical milling machine, a jar mill, a ball mill, or a household mixer. Milling equipment 10 may be advanced types of machinery such as a planetary mill, an industrial vertical roller mill, or any other milling device.

Precursor 20 may be a coal combustion product and may include particulates driven out of coal-fired boilers along with flue gases. Precursor 20 may include a single precursor or may include more than one precursor. Precursor 20 may include fly ash, blast furnace slag, and/or metakaolin. Precursor 20 may include oxides of silicon, aluminum iron, and calcium. Precursor 20 may also include oxides of magnesium, potassium, sodium, titanium, and sulfur. Precursor 20 may include silicates, aluminosilicates, and calcium-alumina-silicates. Precursor 20 may include solid sodium hydroxide, solid sodium silicate, solid potassium hydroxide, solid potassium silicate, mullite, anhydrous calcined form of the clay mineral kaolinite, and combinations thereof. Precursor 20 may include gravel and sand constituents of local resources and materials.

Activator 30 may be alkali and alkaline earth metal activators in solid form. Activator 30 may include alkali and alkaline earth metal substances such as lithium, sodium, potassium, silicates, aluminates, hydroxide as well as carbonates and similar metal substances of calcium, and magnesium. Activator 30 may include a single activator or may include more than one activator.

Activator 30 may be selected from industrial waste such as hydroxide/sulfates of sodium, calcium, and magnesium from waste generated in an industry such as brine treatment. Activator 30 may be solid sodium hydroxide, solid sodium silicate, solid anhydrous sodium silicate, solid sodium silicate pentahydrate potassium hydroxide, potassium silicate, rice husk ash, and/or combinations thereof.

At 102, precursor 20 and activator 30 may be placed separately, or in any combination, into chamber 15 of milling equipment 10. Milling equipment 10 may dry grind or dry ground precursor 20 and activator 30 into a dry powder 60. Milling equipment 10 may dry grind or dry ground precursor 20 and activator 30 for a duration ranging from about 15 minutes to about 24 hours depending on quantities of precursor 20 and activator 30 being milled. Milling may be performed to obtain simultaneous and synergistic chemical reactions among precursor 20 and activator 30 so as to convert the material from unreactive to reactive and produce a precursor capable for polymerization during geopolyemrization process. Milling may be performed to precursor 20 and activator 30 to obtain enhanced geopolyemric functionality by developing desired “inter transition zone” necessary for achieving bonding of the constituents within the geopolymer concrete system to obtain desired functionality for a targeted application. Precursor 20 and activator 30 may be milled with precursor 20 and activator 30 materials containing a major quantity of silica and alumina milled together first followed by the addition of materials with solid sodium hydroxide/potassium hydroxide and then followed by addition of either rice husk silica or sodium silicate/potassium silicate.

At 104, dry powder 60 may be removed from milling equipment 10, Dry powder 60 may include milled precursor 20 and milled activator 30 and may have particles of a uniform size from about 45 microns to about 75 microns, more preferably from about 45 microns to about 60 microns. Geopolymer formulation 60 may provide a geopolymer formulation with simultaneous and synergistic chemical reactions among the appropriately selected raw materials for obtaining a specific functional geopolymer. Geopolymer formulation 60 may be a cement-free, tailored solid powder of geopolymer.

Water and optional aggregate may be added to geopolymer formulation 60 to form a geopolymer mortar for casting the materials in the molds of desired dimensions. Geopolymer formulation 60 may not require a hazardous alkaline activator solution to make geopolymeric cementitious materials.

Geopolymer formulation 60 may be a fast-setting geopolymer mortar/concrete and may contain fly ash at 10-40 weight %, metakaolin at 20-50 weight % and blast furnace slag at 60-90 weight % as precursor 20 and sodium hydroxide at 10-15 weight % and sodium silicate at 25-37 weight % as activator 30. Geopolymer formulation 60 may be a refractory geopolymer composite and may contain fly ash at 10-40 weight % and mullite at 50-70 weight % as precursor 20 and potassium hydroxide at 10-15 weight % and potassium silicate at 25-37 weight % as activator 30. Geopolymer formulation 60 may be a fast-setting geopolymer mortar/concrete and may contain fly ash at 10-40 weight %, metakaolin at 20-50 weight % and blast furnace slag at 60-90 weight % as precursor 20 and sodium hydroxide at 10-15 weight % and sodium silicate at 25-37 weight % or rice husk ash at 5-10 weight % as activator 30. Geopolymer formulation 95 may be a refractory geopolymer composite and may contain fly ash at 10-40 weight % and mullite at 50-70 weight % as precursor 20 and potassium hydroxide at 10-15 weight % and potassium silicate at 25-37 weight % or rice husk ash at 7-13 weight % as activator 30. Examples of formulations for producing geopolymer 60 are presented in Tables 1, 2, 3 and 4.

TABLE 1
Design mix proportions of “Fast setting Geopolymer concrete” for pavement applications

| | Precursor (g) | | | Activator (g) | | | | | | | | | |
|---|---|---|---|---|---|---|---|---|---|---|---|---|---|
| | | Blast | | Solid | Solid | | Fine | Coarse aggregate | | Results | | | |
| Mix | Fly | Furnace | Metak | Sodium | Sodium | Water | aggregate | 10 mm | 19 mm | Compressive | | | Curing |
| Notation | ash | Slag | aolin | Hydroxide | Silicate | (g) | Sand (g) | (g) | (g) | strength | Age | | condition |
| C50FA + | 500 | 500 | — | 80 | 200 | 310 | 1780 | 1065 | 1600 | 3000 psi | 24 | hr | 70 C. |
| C50BFS | | | | | | | | | | 2100 psi | 24 | hr | Ambient |
| C100FA | 1000 | — | — | 80 | 200 | 210 | 1780 | 1065 | 1600 | 2800 psi | 24 | hr | 70 C. |
| | | | | | | | | | | 4000 psi | 150 | D | 70 C. for |
| | | | | | | | | | | | | | 24 hr & |
| | | | | | | | | | | | | | Ambient for rest |
| | | | | | | | | | | | | | of the duration |
| C40FA + | 400 | 300 | 300 | 62.5 | 156.25 | 345 | 1258 | 885 | 885 | 4800 psi | 14 | D | Ambient |
| 30BFS + | | | | | | | | | | 5400 psi | 28 | D | |
| 30MK | | | | | | | | | | | | | |

TABLE 2
Design mix proportions of “Fast setting Geopolymer mortar”

| | Precursor | | | Activator | | | | | | | |
|---|---|---|---|---|---|---|---|---|---|---|---|
| | | Blast | | | Solid Sodium | | Fine | Results | | | |
| Mix | Fly | Furnace | Metak | Solid Sodium | Silicate | | aggregate | Compressive | | | Curing |
| Notation | ash | Slag | aolin | Hydroxide | (Pentahydrate) | Water (g) | Sand (g) | strength | Age | | Condition |
| M100FA | 400 | — | — | 28.71 | 56.21 | 60 | 400 | 3017 psi | 3.5 | hr | 70 C. |
| | | | | | | | | 3500 psi | 5.5 | hr | 70 C. |
| | | | | | | | | 6345 psi | 24 | hr | 70 C. |
| | | | | | | | | 6876 psi | 3 | D | 70 C. for 24 |
| | | | | | | | | | | | hrs and then |
| | | | | | | | | | | | 30 C. for 2 Days |
| | | | | | | | | 7321 psi | 7 | D | 70 C. for 24 |
| | | | | | | | | | | | hrs and then |
| | | | | | | | | | | | 30 C. for 6 Days |
| M100BFS | — | 400 | — | 28.71 | 56.21 | 158 | 400 | 2489 psi | 24 | hr | Ambient |
| | | | | | | | | 3200 psi | 3 | D | Ambient |
| | | | | | | | | 4500 psi | 7 | D | Ambient |
| | | | | | | | | 4700 psi | 14 | D | Ambient |
| M50FA + | 150 | 150 | — | 24 | 60 | 110 | 640 | 3000 psi | 24 | hr | 70 C. |
| M50BFS | | | | | | | | | | | |
| M40FA + | 160 | 120 | 120 | 40 | 78.3 | 147 | 400 | 2900 psi | 24 | hr | 70 C. |
| M30BFS + | | | | | | | | | | | |
| M30MK | | | | | | | | 3200 psi | 3 | D | 70 C. for 24 |
| | | | | | | | | | | | hrs and then |
| | | | | | | | | | | | 30 C. for 2 Days |
| | | | | | | | | 4806 psi | 7 | D | 70 C. for 24 |
| | | | | | | | | | | | hrs and then |
| | | | | | | | | | | | 30 C. for 6 Days |

TABLE 3
Design mix proportions of “Refractory Geopolymer composite”

| | | Activator | | | | | | |
|---|---|---|---|---|---|---|---|---|
| | | Solid | Solid | | Refractory | Results | | |
| Mix | Precursor | Potassium | Potassium | Water | aggregate | Compressive | | Curing Condition + |
| Notation | (Fly ash) (g) | Hydroxide | Silicate | (g) | Mullite (g) | strength | Age | Temperature exposure |
| Mullite −325 | 268 | 32 | 81.25 | 115 | 535 | 5900 psi | 24 hr | 160 F. for 24 hr |
| mesh | | | | | | 12177 psi | 24 hr | 160 F. for 24 hr + |
| | | | | | | | | 2000 F. for 1 hr |
| Mullite 100 | 268 | 32 | 81.25 | 115 | 535 | 4700 psi | 24 hr | 160 F. for 24 hr |
| mesh | | | | | | 7228 psi | 24 hr | 160 F. for 24 hr + |
| | | | | | | | | 2000 F. for 1 hr |

TABLE 4
Design mix proportions of “Fast setting Geopolymer mortar” cured under microwave radiation

| | | Activator | | | | | | | |
|---|---|---|---|---|---|---|---|---|---|
| | | Solid | Solid Sodium | Solid Sodium | | Fine | Results | | |
| Mix | Precursor | Sodium | Silicate | Silicate | Water | aggregate | Compressive | | |
| Notation | Fly ash | Hydroxide | (Pentahydrate) | (Anhydrous) | (g) | Sand (g) | strength | Age | Curing Condition |
| PM100FA | 400 | 28.71 | 56.21 | — | 60 | 400 | 3017 psi | 3.5 hr | 70 C. |
| | | | | | | | 10189 psi | 3.5 hr + 4 min | 70 C. for 3.5 hr |
| | | | | | | | | microwave | and then microwave |
| | | | | | | | | | cured at intervals |
| | | | | | | | | | of 10 sec for 4 minutes. |
| | | | | | | | 3500 psi | 5 hr | 70 C. |
| | | | | | | | 3832 psi | 5 hr + 1 min | 70 C. for 5.5 hr |
| | | | | | | | | microwave | and then microwave |
| | | | | | | | | | cured at intervals |
| | | | | | | | | | of 30 sec for 1 minute. |
| AM100FA | 400 | 28.71 | — | 56.21 | 80 | 400 | 2300 psi | 5 hr | 70 C. |
| | | | | | | | 2954 psi | 5 hr + 1 min | 70 C. for 3.5 hr |
| | | | | | | | | microwave | and then microwave |
| | | | | | | | | | cured at intervals |
| | | | | | | | | | of 30 sec for 1 minute. |

In an experimental example, fast setting geopolymer concrete compositions yielded a compressive strength of 4000 psi after 5 months of being subjected to extreme weather conditions and temperatures of 32 C to −6 C thus proving the durability. In another experimental example, geopolymer formulation 60 may produce a refractory functional geopolymer mortar that can sustain a high temperature of 1100° C. with no shrinkage or cracking and give a compressive strength of 12,177 psi. In another experimental example, geopolymer formulation 60 may produce a refractory geopolymer composite with a compressive strength of 5900 psi when cured at 160° F. for 24 hours prior to high temperature exposures. In another experimental example, geopolymer formulation 60 may produce a fast-setting geopolymer mortar composition with a compressive strength of 3017 psi in 3.5 hours and 6345 psi in 24 hours when cured at 70° C. In another experimental example, geopolymer formulation 60 may produce a fast-setting geopolymer mortar composition with a compressive strength of 4500 psi in 7 days hours when cured at ambient temperature. In another experimental example, geopolymer formulation 60 may produce a fast setting geopolymer composite with a compressive strength of 10189 psi when cured at 160° F. for 3.5 hours prior to microwave curing of 4 minutes at intervals of 10 seconds.

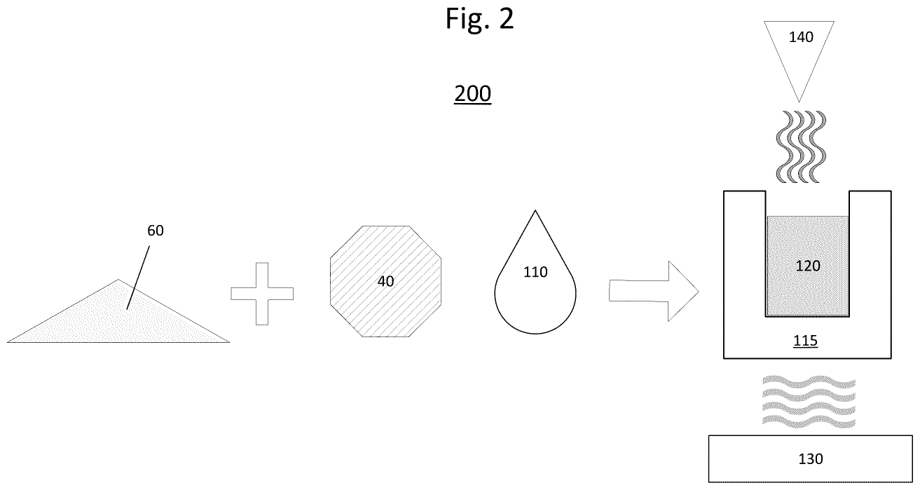

FIG. 2 illustrates another example system that can be utilized to produce a geopolymer mortar or concrete utilizing the geopolymer formulation of FIG. 1 in accordance with at least some embodiments described herein. Those components in FIG. 2 that are labeled identically to components of FIG. 1 will not be described again for the purposes of brevity. System 200 may include geopolymer formulation 60, aggregate 40, water 110, a mold 115, a heater 130, and a microwave source 140.

Geopolymer formulation 60 may be mixed with aggregate 40 and water 110 to produce a geopolymer mortar or concrete 120, depending on type of aggregate used, which may be cast into a mold 115 to set and cure. Geopolymer formulation 60 may also be produced specific to other applications and may be mixed with aggregate 40 and water 110 to produce a geopolymer paste, a geopolymer concrete, or a sprayable geopolymer.

Aggregate 40 may be coarse through medium grained particulate material which may be used in construction. Aggregate 40 may include sand, gravel, crushed stone, slag, recycled concrete and geosynthetic aggregates. Aggregate 40 may be locally sourced and may include local soil-mineral strata resource materials such as clay minerals, gravel, and sands. Aggregate 40 may include a single aggregate or may include more than one aggregate. Aggregate 40 may be fine aggregate with particles sized small enough to pass through a 3/16 inch (4.75 mm) sieve. Aggregate 40 may be coarse aggregate with particles sized around 10 mm or around 19 mm. Aggregate 40 may include more than one aggregate and may include both fine aggregate and broad aggregate.

Geopolymer mortar or concrete 120 may set and cure within mold 115. Geopolymer mortar or concrete 120 may cure at ambient temperature for a time period of 1-150 days. In some embodiments, geopolymer mortar or concrete 120 may be cured at a temperature of about 70° C. or 160° F. by heater 130 for about 24 hours. In other embodiments, geopolymer mortar or concrete 120 may be cured at a temperature of about 70° C. by heater 130 for about 3.5 hours and then cured with microwaves from microwave source 140 at intervals of about 10 seconds for about 4 minutes. In other embodiments, geopolymer mortar or concrete 120 may be cured at a temperature of about 70° C. by heater 130 for about 5 hours and then cured with microwaves from microwave source 140 at intervals of about 30 seconds for about 1 minute. In other embodiments, geopolymer mortar or concrete 120 may be cured at a temperature of about 70° C. by heater 130 for about 3.5 hours and then cured with microwaves from microwave source 140 at intervals of about 30 seconds for about 1 minute. In other embodiments, geopolymer mortar or concrete 120 may be cured at ambient temperature for about 3.5 hours and then cured with microwaves from microwave source 140 at intervals of 10 seconds for about 4 minutes. Geopolymer mortar or concrete 120 may be cured under relative humidity of 50-90%.

A geopolymer formulation in accordance with the present disclosure may provide a geopolymer preparation which releases only 0.25 tons of carbon dioxide for every ton of geopolymer produced. A geopolymer formulation in accordance with the present disclosure may provide a geopolymer made from formulation industrial waste such as fly ashes from thermal power plants, slag from the steel industry, synthetic chemicals including sodium hydroxide/potassium hydroxide and sodium silicate/potassium silicate and river sand as fine aggregate. A geopolymer formulation in accordance with the present disclosure may minimize the use of fly ashes in making geopolymer.

A geopolymer formulation in accordance with the present disclosure may provide a novel and energy-efficient process for the use of localized soil clay minerals, along with fly ashes/slags for making advanced geopolymer useful for a broad application spectrum. A geopolymer formulation in accordance with the present disclosure may provide a novel process of mechanochemical activation with an optional thermal treatment at temperature range of 400 to 600° F. A geopolymer formulation in accordance with the present disclosure may provide a geopolymer formulation which requires the use of only water in place of the use of alkaline activator solutions necessary in the conventional process of making geopolymer using a two-part system.

A geopolymer formulation in accordance with the present disclosure may utilize soil and clay mineral strata as new materials for making advanced geopolymers and reduce the dependency on the use of fly ashes and slags from thermal power plants and the steel industry. A geopolymer formulation in accordance with the present disclosure may provide a novel innovative process for making tailored advance geopolyemric formulations which are useful for a broad application spectrum based on the chemical and mineralogical characteristics of the raw materials. A geopolymer formulation in accordance with the present disclosure may provide an innovative and environment-friendly process for making advanced geopolyemric formulations using local resources along with fly ashes/slag.

A geopolymer formulation in accordance with the present disclosure may be scalable for commercial exploitation for a broad application spectrum when incorporating appropriate additives including a) fast setting b) high strength c) heat and fire resistant d) corrosion resistant e) blast resistant f) 3-D printable geopolyemric ink for construction activity, and/or g) simultaneously shielding EMI and X-ray, Gamma and Neutron radiation. A geopolymer formulation in accordance with the present disclosure may reduce the dependency on fly ash substantially in making advanced geopolymeric formulations by requiring only 30 percent fly ash and 30 percent slag as against conventional geopolymer which requires the use of 100 percent fly ashes. A geopolymer formulation in accordance with the present disclosure may reduce material transportation costs by utilizing locally available sand as fine and locally available coarse aggregate. A geopolymer formulation in accordance with the present disclosure may produce advanced geopolymeric formulations useful for multifarious application of geopolymer in the form of i) sprayable geopolymer ii) geopolymer paste iii) geopolymer mortar or iv) geopolymer concrete with enhanced favorable properties for targeted applications.

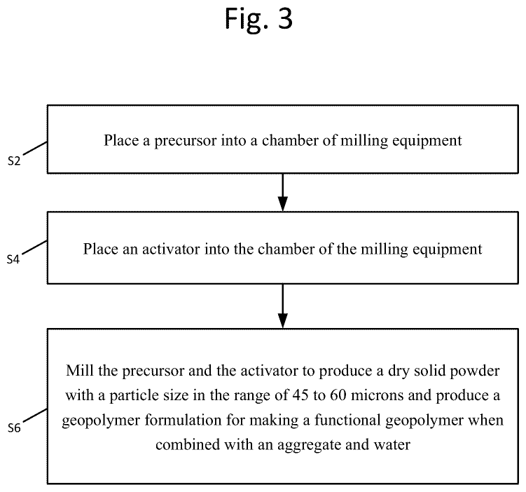

FIG. 3 illustrates a flow diagram for an example method for making a geopolymer formulation in accordance with at least some aspects presented herein. This example process may include one or more operations, actions, or functions as illustrated by one or more of blocks S2, S4, and/or S6. Although illustrated as discrete blocks, various blocks may be divided into additional blocks, combined into fewer blocks, or eliminated, depending on the desired implementation.

The method may begin at block S2, “Place a precursor into a chamber of milling equipment.” At block S2, a precursor may be placed into a chamber of milling equipment. The milling equipment may be a horizontal or vertical milling machine, a jar mill, a ball mill, a household mixer, a planetary mill, an industrial vertical roller mill, or any other milling device. The precursor may include oxides of silicon, aluminum iron, calcium, magnesium, potassium, sodium, titanium, and sulfur. The precursor may include silicates, aluminosilicates, calcium-alumina-silicates, solid sodium hydroxide, solid sodium silicate, solid potassium hydroxide, solid potassium silicate, mullite, and combination thereof. The precursor may include gravel and sand constituents of local resources and materials.

The method may continue from block S2 to block S4, “Place an activator into the chamber of the milling equipment.” At block S4, an activator may be placed into the chamber of the milling equipment. The activator may include alkali and alkaline earth metal substances such as lithium, sodium, potassium, silicates, aluminates, hydroxide as well as carbonates and similar metal substances of calcium, and magnesium. The activator may be selected from industrial waste such as hydroxide/sulfates of sodium, calcium, and magnesium from waste generated in an industry such as brine treatment. The activator may be solid sodium hydroxide, solid sodium silicate, potassium hydroxide, potassium silicate, rice husk ash, and/or combinations thereof.

The method may continue from block S4 to block S6, “Mill the precursor and the activator to produce a dry solid powder with a particle size in the range of 45 to 60 micron and produce a geopolymer formulation for making a functional geopolymer when combined with an aggregate and water.” At block S6, the precursor and the activator may be milled to produce a dry solid powder with a particle size in the range of 45 to 60 microns. The milling equipment may dry grind or dry ground the precursor and the activator for a duration ranging from about 15 minutes to about 24 hours depending on quantities of precursor and activator being milled. The milling may be performed to obtain simultaneous and synergistic chemical reactions among the precursor and the activator to convert the material from unreactive to reactive so as to produce a precursor capable for polymerization during a geopolyemrization process. The dry powder may produce a geopolymer formulation for making a functional geopolymer when combined with an aggregate and water.

Finally, the processes and techniques described herein are not inherently related to any apparatus and may be implemented by any suitable combination of components. Further, various types of general-purpose devices may be used in accordance with the teachings described herein. It may also prove advantageous to construct specialized apparatus to perform the method steps described herein. This disclosure has been described in relation to the examples, which are intended in all respects to be illustrative rather than restrictive.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A geopolymer formulation for making a functional geopolymer when combined with an aggregate and water, the geopolymer formulation comprising:
a precursor including an oxide; and
an activator;
wherein the geopolymer formulation is a dry solid powder with a particle size in the range of 45 to 60 micron.

2. The geopolymer formulation of claim 1, wherein the precursor comprises fly ash, metakaolin and blast furnace slag, the activator comprises sodium hydroxide and sodium silicate, and the geopolymer formulation is suitable for making a fast setting geopolymer mortar/concrete.

3. The geopolymer formulation of claim 2, wherein the precursor comprises fly ash at 10-40 weight %, metakaolin at 20-50 weight %, and blast furnace slag at 60-90 weight %, and the activator comprises sodium hydroxide at 10-15 weight % and sodium silicate at 25-37 weight %.

4. The geopolymer formulation of claim 1, wherein the precursor comprises fly ash and mullite, the activator comprises potassium hydroxide and potassium silicate, and the geopolymer formulation is suitable for making a refractory geopolymer composite.

5. The geopolymer formulation of claim 4, wherein the precursor comprises fly ash at 10-40 weight % and mullite at 50-70 weight %, and the activator comprises potassium hydroxide at 10-15 weight % and potassium silicate at 25-37 weight %.

6. The geopolymer formulation of claim 1, wherein the precursor comprises fly ash, metakaolin, and blast furnace slag, the activator comprises sodium hydroxide and sodium silicate or rice husk ash, and the geopolymer formulation is suitable for making a fast-setting geopolymer mortar/concrete.

7. The geopolymer formulation of claim 6, wherein the precursor comprises fly ash at 10-40 weight %, metakaolin at 20-50 weight %, and blast furnace slag at 60-90 weight %, and the activator comprises sodium hydroxide at 10-15 weight % and sodium silicate at 25-37 weight % or rice husk ash at 5-10 weight %.

8. The geopolymer formulation of claim 1, wherein the precursor comprises fly ash and mullite, the activator comprises potassium hydroxide and potassium silicate or rice husk ash, and the geopolymer formulation is suitable for making a refractory geopolymer composite.

9. The geopolymer formulation of claim 8, wherein the precursor comprises fly ash at 10-40% and mullite at 50-70%, the activator comprises potassium hydroxide at 10-15 weight % and potassium silicate at 25-37 weight % or rice husk ash at 7-13 weight %, and the geopolymer formulation is suitable for making a refractory geopolymer composite.

10. The geopolymer formulation of claim 1, wherein the geopolymer formulation produces a fast setting geopolymer concrete composition with a compressive strength of 2000 psi after curing at ambient temperature for 24 hours.

11. The geopolymer formulation of claim 1, wherein the geopolymer formulation produces a fast setting geopolymer concrete composition with a compressive strength of 3000 psi after curing at ambient temperature for three days or heat curing at 70° C. for 24 hours.

12. The geopolymer formulation of claim 1, wherein the geopolymer formulation produces a fast-setting geopolymer concrete composition with a compressive strength of 5400 psi after curing at ambient temperature for 28 days.

13. A method of making a geopolymer formulation, the method comprising:
placing a precursor into a chamber of milling equipment;
placing an activator into the chamber of the milling equipment; and
milling the precursor and the activator to produce a dry solid powder with a particle size in the range of 45 to 60 microns and produce a geopolymer formulation for making a functional geopolymer when combined with an aggregate and water.

14. The method of claim 13, further comprising:
mixing aggregate and water with the cured dry powder to produce a geopolymer mortar; and
casting the geopolymer mortar into a mold.

15. The method of claim 14, further comprising heat curing the geopolymer mortar in the mold at a temperature of about 70° C. for about 24 hours.

16. The method of claim 14, further comprising ambient curing the geopolymer mortar in the mold at ambient temperature for about 1-150 days.

17. The method of claim 14, further comprising:
heat curing the geopolymer mortar in the mold at a temperature of about 70° C. for about 3.5 hours; and
microwave curing the geopolymer mortar in the mold at intervals of 10 seconds for about 4 minutes.

18. The method of claim 14, further comprising:
heat curing the geopolymer mortar in the mold at a temperature of about 70° C. for about 5 hours; and
microwave curing the geopolymer mortar in the mold at intervals of about 30 seconds for about 1 minute.

19. The method of claim 14, further comprising:
heat curing the geopolymer mortar in the mold at a temperature of about 70° C. for about 3.5 hours; and
microwave curing the geopolymer mortar in the mold at intervals of about 30 seconds for about 1 minute.

20. A geopolymer formulation for making a functional geopolymer when combined with an aggregate and water, the geopolymer formulation comprising:
a precursor including fly ash and blast furnace slag; and
an activator including sodium hydroxide and sodium silicate or rice husk ash;
wherein the geopolymer formulation is a dry solid powder with a particle size in the range of 45 to 60 microns, the geopolymer formulation is for a refractory geopolymer composite with a compressive strength of 5900 psi when cured at 160° F. for 24 hours prior to high temperature exposure.
